(19) United States
(12) Patent Application Publication
(10) Pub. No.: US 2013/0251822 A1
(43) Pub. Date: Sep. 26, 2013

(54) BIOCIDAL ALDEHYDE COMPOSITION

(71) Applicant: Howard Martin, Potomac, MD (US)

(72) Inventor: Howard Martin, Potomac, MD (US)

(21) Appl. No.: 13/899,000

(22) Filed: May 21, 2013

Related U.S. Application Data
(62) Division of application No. 13/311,787, filed on Dec. 6, 2011.

(51) Int. Cl. A01N 57/20

(52) U.S. Cl. CPC A01N 57/20
USPC 424/661; 514/75

(57) ABSTRACT

A combination biocide (Glutaraldehyde or OPA), quaternary phosphonium biocide, alcohol, and functional excipients for surface-sterilization of medical instruments and other objects. The quaternary phosphonium biocide is preferably TTPC, and the alcohol isopropyl alcohol. The OPA is the dialdehyde C₆H₄(CHO)₂, which produces an inherent bacteriostatic effect, lowering surface tension, and aiding in the spread of the TTPC on the instrument surface where it is readily absorbed by the negative surfaces of proteins and bacteria. It thus serves as a binding agent between the TTPC and the application surface. The foregoing constituents are combined in preferred concentrations within acceptable ranges to provide a synergistic formulation that combines biocidal molecules in a biological chemical system that actively transports itself into the cells, through biofilm and cell wall/membranes, thereby overcoming penetration restraints to improve kill and kill time, without the need for activation or any time or temperature control.

### CROSS-REFERENCE TO RELATED APPLICATION(S)

The present application is a division of U.S. patent application Ser. No. 13/311,787 filed 6 Dec. 2011 (which derives priority from U.S. provisional application Ser. No. 61/562,812 filed 22 Nov. 2011 and is a continuation-in-part of U.S. patent application Ser. No. 12/584,648 filed Sep. 9, 2009, now U.S. Pat. No. 8,088,829).

### BACKGROUND OF THE INVENTION

1. Field of the Invention

The present invention relates to chemical disinfection and sanitizing and, more particularly, to an improved biocidal aldehyde composition for surface disinfection/sterilization.

2. Description of the Background

The purpose of disinfection is to reduce microbial contamination to an innocuous level. There is a widespread need for effective microbials in the healthcare industry (e.g., medical instrument sterilization). There are also myriad existing compositions that purport to solve the need, but in reality the results are mixed. Moreover, certain chemicals are inappropriate for certain situations. For example, Iodine is one of the most effective antimicrobial agents known. It is essentially bactericidal, and in diluted form the bacteriostatic and bactericidal action is practically identical. Iodine is active against a broad series of organisms including TB, pathogenic fungi, and viruses of both lipophilic and hydrophilic types. Although effective as an antiseptic wash and irrigant over a wide pH range it is best at an acid pH.

There are several combinations of quaternary ammonium compounds used for biocidal purposes, but they are application specific. Quaternary ammonium compounds are inhibitory to vegetative organisms and fungi but are not tuberculocidal or sporicidal. Quaternary ammonium compounds cannot generally be provided in concentrate form because they are inactivated by hard water (water with more than 400 ppm of carbonates). They also present an environmental problem. Certain dual quaternary ammonium compounds have improved biocidal activity, stronger detergency and a low level of toxicity, but they still have not solved the hard water problem that reduces or inhibits their activity, nor the environmental problems. For example, U.S. Pat. No. 4,983,635 issued Jan. 8, 1991, and U.S. Pat. No. 5,284,875 issued Feb. 8, 1994, solved the hard water problem and improved but did not effectively solve the biocidal activity. Moreover, due to the addition of phenolics this prior art increased the toxicity problem.

Glutaraldehyde is still currently the most important high level disinfectant/sterilant in health care usage. However, its use over the years has shown it to be erratic, failing in certain tuberculosis (TB) tests. Moreover, it requires burdensome time/temperature control (residence time of 45-90 minutes for disinfection, and controlled temperature from 20 C to 25-30 C). Consequently, glutaraldehyde has very limited usage in clinical settings where temperatures are between 20-22 degrees C. If the user fails to warm the solution or its labels do not indicate that this warming should accompany its use, there is risk of ineffectiveness. The most popular commercial product Cidex™ requires activation and dating to make it useful. Thus, proper usage entails a three step procedure and meticulous record-keeping regarding date of activation.

A different aldehyde, orthophthalaldehyde (OPA), has now come into use. Johnson and Johnson developed an original formulation in the late 1980s described in U.S. Pat. No. 4,851,449 and in subsequent continuation in part application(s). This OPA has been approved by the FDA as a high level disinfectant with a twelve minute disinfection time at 20-22 degrees C. Its sterilization time is listed between 24-32 hours. OPA interacts with amino acids and proteins of microorganisms. OPA is lipophilic which improves its uptake in the cell walls. Thus, OPA has been shown to be more penetrating than glutaraldehyde. The J&J OPA concentration is 0.55% by weight at a pH 3-9. It has been shown to be effective in a purely aqueous immersion solution. Metrex Research Corp. continues to sell a modified formulation referred to as OPA+, with an increased OPA concentration of 0.6% (0.05% more OPA), plus buffers, a corrosion inhibitor, and a chelating agent. In essence the formula is the same as the J&J product, with no faster kill time, but claims of 60% more treatment. However, if one looks at the mechanism by which OPA works it becomes biologically clear where the weaknesses lie. OPA is an aromatic dialdehyde. The severe test for cidal effectiveness are gram negative bacteria, mycobacteria and sporecoated organisms. OPA is not completely effective in clinical use at its concentration of 0.5% and pH 6.5. Failures occur and have been reported in literature surveys. The benzene ring of OPA is a planar, rigid structure. Therefore, OPA has no flexibility as a result of steric hinderance. In addition, OPA only reacts with primary amines. OPA is bactericidal at low concentrations to staphylococci and gram − bacteria. The poor sporicidal activity is due to low concentration and low pH. It has been noted that if the temperature is raised from the normal 20 degrees C. to 30 degrees it improves. However, this is impractical. Regarding mycobacteria, a similar problem is present. The lipophilic aromatic component of OPA does not reliably penetrate the lipid-rich cell wall of mycobacteria and gram (−) bacteria. Indeed, subsequent studies show that OPA exhibits selective bactericidal activity, good against Pseudomonas aeruginosa, limited activity against mycobacterial strains. See, Shackelford et al., Use of a New Alginate Film Test To Study The Bactericidal Efficacy Of The High-Level Disinfectant Ortho-Phthalaldehyde, Journal of Antimicrobial Chemotherapy, 57(2):335-338 (2006).

Presently, there is no single universally effective biocide due to variable physical, chemical and biological parameters. A biocide must have interactions of a variegated nature in order to have a chance of reasonable effectiveness. What is needed is a simple and improved one-step formulation.

In copending U.S. patent application Ser. No. 12/584,648 filed Sep. 9, 2009 the present inventor suggests a synergistic combination of quaternary ammonium cations with glutaraldehyde, ortho-phthalaldehyde, isopropyl alcohol, and excipient constituents combined in preferred concentrations within acceptable ranges to provide a synergistic biological chemical system that actively transports itself into the cells, through the cell wall/membranes, thereby overcoming penetration restraints and improving kill and kill time, without the need for activation or any time or temperature control. The present inventor has established that the goal can be accomplished more effectively with combinations of tributyl tetradecyl phosphonium chloride (TTPC) (or, alternatively, tetrakis (hydroxymethyl) phosphonium sulfate (THPS)), with the following biocides: glutarladehyde, orthophthalaldehyde and/or isopropyl alcohol.

Thus, the present application discloses an improvement to the preceding formulation in which a quaternary phosphonium salt, preferably tributyl tetradecyl phosphonium chloride (TTPC), is substituted for the dual chain quaternary ammonium to achieve markedly improved results. Alternatively, Tetrakis (hydroxymethyl) phosphonium sulfate (THPS) may be used in lieu of TTPC. The following discussion is explanatory and evidenced based using either glutaraldehyde or OPA for more effective disinfection/sterilization in industrial/commercial uses such as oil and gas recovery.

TTPC has improved thermal and chemical stability based upon its unique miscibility and solvating properties. TTPC is less dense than water and is anion dependent, which makes it sensitive to various solutes and thereby a better component carrier for the Glut OPA, IPA, ClO₂. It also enhances catalysis. TTPC is a phosphonium salt with the phosphonium Ion (PH4+) replacing the amine in the dual chain quat formulation. The quat to be replaced had a tendency to foam especially above pH 8. The mechanism of kill is cationic whereby an electrostatic bond is formed with the cell wall affecting permeability and denaturing proteins. The effective pH is 6-8.5 and is only bacteriostatic.

TTPC is a broad spectrum biocide of the alkyl phosphonium group. TTPC is cationic also but with low foaming tendency, a high level of hydrolytic stability, and it functions over a much broader pH range from 2-11. TTPC damages cell walls, as explained further, and affects cell enzyme process. TTPC is not affected by saline or brine as is the dual chain quat formulation. TTPC kills at much lower concentrations than the dual chain quat formulation and is faster acting. TTPC aids in biofilm penetration and delays biofilm regrowth, which is extremely meaningful medical usage. TTPC is a neoteric solvent/biocide that has been developed with remarkable individual properties. It is an ionic liquid that has microbiocidal qualities, solvent qualities, and detergent qualities, all extremely meaningful for surface sterilization applications.

### SUMMARY OF THE INVENTION

It is, therefore, an object of the present innovation to provide a novel strategy for potentiating and improving the cidal effectiveness of ortho-phthalaldehyde or glutaraldehyde by a synergistic formulation that combines cidal molecules with a biological chemical system that actively transports itself into the cells, through the biofilm and cell wall/membranes, thereby overcoming penetration restraints.

It is another object to improve cidal effectiveness against a broader range of refractory microorganisms within ecological and environmentally acceptable parameters, essentially yielding a green biocide.

In one embodiment designed for healthcare, these and other objects are accomplished by a novel combination of glutaraldehyde or OPA, and a surfactant quaternary phosphonium biocide that absorbs onto a surface and alters the free energy of that surface, and alcohol. The quaternary phosphonium biocide is preferably tributyl tetradecyl phosphonium chloride (TTPC), though tetrakis (hydroxymethyl) phosphonium sulfate (THPS) may also be used. The alcohol is preferably isopropyl alcohol. The OPA is the dialdehyde C₆H₄(CHO)₂, which produces an inherent bacteriostatic effect and lowers surface tension and thus aids in the spread of the TTPC on the biofilm covered surface where it is readily absorbed by the negative surfaces of proteins and bacteria. It thus serves as a binding agent between the TTPC and the application surface. Rather than OPA, a glutaraldehyde of formula C₅H₈O₂ may be substituted in conjunction with the other constituents. The foregoing constituents are combined in preferred concentrations within acceptable ranges to provide a synergistic formulation that combines cidal molecules with a biological chemical system that actively transports itself into the cells, through the biofilm and cell wall/membranes, thereby overcoming penetration

TTPC, in conjunction with the aforementioned single biocides, creates a unique and surprisingly more effective biocidal combination than the cationic amine based dual, chain quats. These new formulations now create an outstanding synergistic interaction due to the new reactive chemistry of the ionic solvent, and improves kill and kill time, without the need for activation or any time or temperature control.

Other objects, features, and advantages of the present invention will become more apparent from the following detailed description of the preferred embodiments and certain modifications thereof.

### DETAILED DESCRIPTION OF THE PREFERRED EMBODIMENT

The present invention is a solution with a synergistic complementarity of constituents that combine to improve the cidal effectiveness of the ortho-phthalaldehyde or glutaraldehyde through a biological chemical system to provide improved results. The present invention allows a one-step formulation for disinfection/sterilization of health care instruments and surfaces by application as an immersion solution, wipe or spray, or as an aqueous solution. The unique chemo-biological formulation described herein improves the cidal effectiveness glutaraldehyde or OPA by the addition of a quaternary phosphonium biocide, TTPC, along with primarily water, plus inert additives as desired including Trienthanol Amine, Glycol Ether, and Sulfonic Acid, the foregoing combination creating a synergistic and unexpected improvement in biocidal effectiveness resulting in faster kill time.

In copending U.S. patent application Ser. No. 12/584,648, the dual chain quaternary ammonium aids in the disinfection/sterilization of health care instruments and surfaces. However, the dual chain quat is a molecular solvent rather than a completely ionic solvent, as is tributyl tetradecyl phosphonium chloride (TTPC). Therefore the outcome reactions are different. The substitution of TTPC for the dual chain quat results in different thermodynamics and kinetics, and improved synergism and killing. The biocidal results are 2× to 4× more effective, and toxicity is reduced.

In the healthcare context, the core constituents of the inventive formulation are a novel combination of glutaraldehyde or OPA, a quaternary phosphonium biocide (TTPC), alcohol, plus inert excipient additives as desired including Trienthanol Amine, Glycol Ether, and Sulfonic Acid and water. The Glutaraldehyde or OPA in combination with the TTPC work in synergy to kill the SRBs more effectively.

The quaternary phosphonium biocide is tributyl tetradecyl phosphonium chloride (TTPC).

The alcohol is preferably isopropyl alcohol.

The OPA is the dialdehyde C₆H₄(CHO)₂, which produces an inherent bacteriostatic effect and lowers surface tension and thus aids in the spread of the TTPC on the biofilm covered surface where it is readily absorbed by the negative surfaces of proteins and bacteria. It thus serves as a binding agent between the TTPC and the application surface. Rather than OPA, a glutaraldehyde may be substituted in conjunction with the other constituents. The alcohol is preferably isopropyl alcohol.

The foregoing constituents are combined in the following preferred concentrations within acceptable ranges, the balance being primarily water, plus inert additives as desired including Trienthanol Amine, Glycol Ether, and Sulfonic Acid.

| Constituent | % by weight | Acceptable Range |
|---|---|---|
| OPA | 5% | 0.25-7% |
| TTPC¹ | .48% | 24-6% (50-1000 ppm) |
| Isopropyl Alcohol | 41.5% | 10-60% |
| Trienthanol amine | 0.5% | 0.25-2% |
| Glycol Ether | 4% | 2%-6% |
| Sulfonic Acid | 2% | 0.2-3% |

¹An equal amount of tetrakis (hydroxymethyl) phosphonium sulfate (THPS) should be used if substituted for TTPC.

The preferred formula amount of constituents indicated above is best suited for clinical usage, and the amounts/concentrations may vary for other uses as described below.

The ortho-phthalaldehyde (OPA) is a chemical compound with the formula C₆H₄(CHO)₂. The molecule is a dialdehyde, consisting of two formyl (CHO) groups attached to adjacent carbon centers on a benzene ring. It is a pale yellow solid and is readily commercially available. The OPA, in addition to its inherent bacteriostatic effect (see Grump, W. “Disinfectants and Antiseptics” in Kirk-Othmer, Encyclopedia of Chemical Technology, vol. 7, 3rd ed., 1979) lowers surface tension and thus aids in the spread of the TTPC on the biofilm covered surface where it is readily absorbed by the negative surfaces of proteins and bacteria. (Block, S, Disinfection, Sterilization & Preservation, Lea & Febiger, Phil., 1983). It thus serves as a binding agent between the TTPC and the application surface. This multi-purpose component helps create the unique aspect of the formulation.

The Glutaraldehyde is of formula C₅H₈O₂ in alcohol-solution form.

The alcohol is preferably isopropyl alcohol. The use of isopropyl alcohol is involved as a solvent and aid in the disruptive mechanism of the biocidal formula by interaction with lipids and a denaturing action of proteins. Essentially, this is a reinforcement of the quats action along with the displacement of water molecules. This results in enzyme damage and conformational membrane changes resulting in cell leakage through membrane damage.

It is the rapidly unexpected cidal effectiveness that is created by this unique and unusual combination of components that together work in a synergistic and additive manner to develop a new and unusual combination formula. The ability of the TTPC to work in medical environments makes it a key adjunct. The disruption of the cytoplasmic membrane due to the TTPC adsorption on the cell surface and membrane is the important factor.

The above-described formulation illustrates the improved kill, and improved kill time, all at normal 20 degrees C. Overall, the newly developed biologically designed chemical combination enhances biocidal effectiveness. This is accomplished by improving and opening the diffusion channels through the cell wall, leading to disruption of the cytoplasmic membrane. This is partly accomplished by adsorption of the cidal agent via the surfactant to the bacterial cell surface and cytoplasmic membrane.

It should now be apparent that the above-described improvement in aldehyde formulation results in a one step biocidal process requiring no activation, no dating (record-keeping) and is based upon biochemical principles that improves effectiveness. Toxicity is reduced, cidal effectiveness greatly improved, and no temperature control is required inasmuch as the formulation remains effective within federal standards at between 20-22 degrees C. Moreover, handlers are safer due to lack of odor, low vapor pressure, reduced antigenic properties and improved waste disposal. The formulation may be considered a “green” formulation inasmuch as it is less toxic to the environment and ecosystem.

The above-described embodiment is especially well-suited for healthcare such as sterilizing medical instruments, and the following examples illustrate the efficacy in this context.

### EXAMPLES

When TTPC was added to the core glutaraldehyde or OPA as a substitute for dual chain quaternary ammonium the effective kill time was twice as fast (2×) based upon log reduction. Similarly, the TTPC reduced the effective kill time of acid-producing bacteria (APB) by almost 50%. Although the kill speed of TTPC alone was 20% slower than the glut/quat formula of copending U.S. patent application Ser. No. 12/584,648, when incorporated with glutaraldehyde as a substitute for dual chain quaternary ammonium the kill time increased to four times faster, evidencing the synergism of the present combination.

Another test with the organism of Pseudomonas aeruginosa was carried out using a suspension of 10⁴ ml of the present formulation with 5% serum added as bioburden. The suspension was exposed to TTPC/glutaraldehyde and TTPC/OPA embodiments in concentration of from 50 ppm 100 ppm, 500 ppm, 1,000 ppm for periods of 4 hours, 1 hour, and 30 minutes. The results showed complete kill in all time frames and at all concentrations. This test was repeated at concentrations of 10⁵ ml and 10⁶ ml. The results were similar illustrating that the concentration bacteria did not require titration of biocide. The effective range of bactericidal activity for incorporation of TTPC within the varied glutaraldehyde or OPA materials was from 50 ppm to 1000 ppm.

A test with chlorine dioxide (ClO₂) and TTPC versus Pseudomonas aeruginosa was performed at 10⁵ ml with ClO₂ of 10 ppm. This alone gave a 1 log reduction in 30 min exposure. TTPC alone at 50 ppm gave a 2 log reduction. The combination of ClO₂ and TTPC of 5ppm and 10 ppm gave a 5 log reduction in 30 min. The synergy of ClO₂ and TTPC is much more effective than the individual components.

Isopropyl alcohol (IPA) and quaternary ammonium kill Pseudomonas in 2 min with concentrations of 0.24% and. IPA 41.5%. A mixture of 18% IPA and 0.10% TTPC was compared in rate of kill at 2 minutes with 10⁶ ml of Pseudomonas. The kill was 0 failures in 60 tubes. This again shows the unusual strength of synergy of TTPC with the various tested biocides. The IPA was important as this formulation has a high volatile organic compound (VOC) issue. By reducing the alcohol and TTPC level it will fall within more healthy parameters.

As a result of the foregoing cidal effects, the synergy index was between 0.6 and 0.8 (below 1.0 indicates synergy effectiveness) for the various combinations of chemistries. This illustrates a most notable-improvement in bactericidal effectiveness.

Comparing the glutaraldehyde/quaternary ammonium formulation to glutaraldehyde/TTPC of the present formulation the rate of kill was faster by 1 log in 30 min but the concentration of TTPC was 50% less than the quat amine in the prior formulation. Thus, there is improved cidal and ecological result in the sterilization context. The OPA/quat versus OPA/TTPC of the present formulation reacted in similar fashion during testing. Both Glut and OPA embodiments of the present invention can be reduced overall by 10%, and the TTPC (versus quaternary ammonium component) can be reduced by 50%. Clearly this is a safer more ecological biocide for medical sterilization.

TTPC is less volatile thereby reducing the release of VOCs. Thus, the present formulation is a tailored solvent micro biocide that optimizes cidal effectiveness as well as decreases ecological toxicity. The formulation also exhibits more stable thermal conditions, remaining liquid in a range of 300 C (−96 to 200 C), working in a pH range of 2-12, succeeds in solvating organic, inorganic and polymeric materials, catalyzes, and is very miscible in the present solution.

In the particular context of disinfection/sterilization of health care instruments and surfaces, TTPC has superior biofilm removability compared to quaternary ammonium. As such there is actually a slight increase in planktonic microbes which are more susceptible to biocide/TTPC effects. Individual biocides affect the physiology of the cell quite differently. Understanding and elaborating their effects allows for a more intelligent (safe and effective) and innovative combination of mechanistically different agents so that a more effective and efficient formulated compound is developed. The present combination of chemicals creates an improved general synergy of action resulting in a more efficient and targeted application of a biocide mixture rather than multiple single biocides, surprisingly and significantly adding to the synergistic effectiveness of the biocidal combinations with TTPC of glutaraldehyde, orthophthalaldehyde, Isopropyl Alcohol, Chlorine Dioxide, separately in individual formulation. This is an example of enhanced quantum complementarity. The importance of the environmental parameter cannot be underestimated based upon the foregoing results. TTPC has a similar margin of exposure as the quats used for killing of aerobic organisms. However, TTPC is 2× more effective than my original glut/quat formula and improves the OPA/quat blend based upon a 5 log reduction in oil frac water. OPA/Quat blend vs. the replacement Quat with TTPC, diluted to 1,000 ppm is essentially non-corrosive to metals including stainless steel. The minimum inhibitory concentration (MIC) for the TTPC usage is 50-500 ppm. Therefore it is safe regarding corrosiveness, an important facet in instrument sterilization. Efficacy in disinfection/sterilization of health care instruments and surfaces shows glut/quat and TTPC alone to be almost equally effective on sulfur reducing bacteria (SRB). The faster cidal action is due basically to the chemistry difference between amine quats and phosphonium salts. The ammonium quats have longer alkyl chains. Instead of amine the difference is a phosphonium ion but also importantly is the alkyl chain length. It has been determined that there is an optimal length for anti-bacterial effectiveness. It was dependent upon chain length and attachment moieties. It was unexpected that the tetradecyl group exhibited the broadest spectrum of activity against the tested microorganisms MRSA, B. subtillis (which are gram +), E coli, pseudomonas aeruginosa (Gram −); candida a fungus, based upon specific chain length. Usually the longer chain was better but not in these cases. The ammonium quat did not kill all the test bacteria in the allotted time of 30 minutes. TTPC did. There are great differences between Gram + and Gram − bacteria in their cell walls. Gram + possess a mesh-like wall of peptidoglycan and teichoic acid. The Gram − wall is complicated. It has in addition to the wall of G+ an outer membrane of lipopolysaccharide and phospholipids that protects the cell.

What is referred to as the S layer adheres to the cell outer membrane. Its pattern is tile-like and associated with the peptidoglycan layer. This layer is susceptible to ion formation and osmotic stress. By attacking this layer the self-assembly ability of cell protection is reduced. This disrupts the glycocalyx (both the capsule and slime/biofilm layer) of the cell.

Capsules outside the cell wall are polysaccharides. As such they contain a great deal of water and protect against hydrophobic biocides. This is why TTPC being amphiphilic is effective—it being both hydrophobic and hydrophilic. Interestingly, the phospholipids themselves are amphiphilic. The membrane proteins are of two types—peripheral (easily disrupted) and integral (not so). Integral proteins arc essential for cell function. TTPC is unusually suited for affecting these proteins by being amphipathic.

The length of the biocide alkyl chain creates a hydrophobic tail. By adjusting the chain as in TTPC, it becomes able to interact with the cytoplasm membrane which is the target site of cationic biocides. However the TTPC worked with a somewhat shorter chain contrary to expectation. Generally the concentration and structure of the surfactant affects the aggregates organization so that amphiphiles (TTPC) give very different morphologies. The chain length of antibacterial activity is based upon micelle aggregation in solution. The optimal alkyl chain length affects the critical micelle concentration (CMC). The ability to rupture the membrane cell wall thereby giving access to the cytoplasmic membrane is key. The rearrangement of the molecular cell wall to form a channel space with enough radius to allow access of the Gluteraldehyde OPA, IPA, ClO₂ with TTPC requires sufficient rupturing for molecular insertion within the cell itself. This disruption is based upon lowering surface tension and bending rigidity weakening based upon negative bubble curvature. This ability to create interfacial fluctuations in the membrane is the hole-nucleation theory of Kabalnov and Wennerstrom (Langmuir, 1996). Access is granted to the inner cytoplasmic membrane made of phospholipids and proteins (phosphoglycerides) similar to Gram + as well as Gram − cells. This access is due to the presence of porin proteins. They form trimers in the outer membrane creating a tube-like water filled channel. With a negative curvature, the edge of this hole allows for transmission to the inner aspect of the periplasmic space and peptidoglycan. TTPC can take advantage of this action. The TTPC portion can then react easily and at a lower concentration of ppm than the quat amines as well as carrying the other cidal components along such as the glutaraldehyde, OPA, IPA, ClO₂. Consequently, TTPC as a quat replacement works via a different mechanism of action, and improves synergy with Gluteraldehyde OPA, ClO₂, IPA. This leads to reduced microbial resistance and rebound, decreased environmental toxicity due to using much lower concentrations of all the chemical components, thereby also reducing costs. From a practical viewpoint, the use of synergistic combinations of TTPC and the aforementioned biocides to inhibit bacterial growth is suitable for reduction in biocide' use while being as effective as higher concentrated biocides. As such the addition of TTPC in lieu of quaternary ammonium aids in the active sustainability of the biocide process. Therefore reactions are carried out in various types of media, can have enhanced reaction rates, higher yields and unconventional selective reactions.

One last interesting yet obscure issue is that of inadvertent nutrient introduction glutaraldehyde, in particular, and less so OPA, that will add greater than 50 mg/l of organic carbon to the media over time. Biocides will naturally degrade over time ultimately falling below their MIC, then added carbon will fuel regrowth of the microbes. Quats do not affect this phenomenon, but TTPC does. Unexpectedly, TTPC aids rapid kill and accelerates removal of the necrotic remnants, reducing the remaining bacteria to very low levels prior to biocide degradation, the chance of regrowth is greatly diminished.

A dual biocide approach is extremely important because they minimize the risk of resistant organisms developing, as well as being more effective against recalcitrant organisms. The unique combinations offer a better opportunity for biofilm slime penetration and dispersion, thereby effecting superior cellular penetration enabling an effective cidal dosing at lower minimum kill concentration levels. It allows for multiple options of kill pathways rather than a single option as is available to single biocides or even dual biocides of related natures. That is the importance of the formulated synergistic effect of cidal biochemical relationships between different chemistries and unusual components.

Although the preferred embodiment uses TTPC in combination with glutaraldehyde, ortho-phthalaldehyde, isopropanol, and chlorine dioxide has been proven effective, one skilled in the art should readily understand that another suitable phosphonium salt might be used in place of TTPC to achieve comparable results. For example, an equal amount of tetrakis (hydroxymethyl) phosphonium sulfate (THPS) may be substituted for TTPC.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A biocidal formulation comprising a quaternary phosphonium biocide, isopropyl alcohol, and excipient constituents.

2. The biocidal formulation according to claim 1, wherein said quaternary phosphonium biocide is tetrakis (hydroxymethyl) phosphonium sulfate (THPS).

3. The biocidal formulation according to claim 1, wherein said quaternary phosphonium biocide is tributyl tetradecyl phosphonium chloride (TTPC).

4. The biocidal formulation of claim 1, further comprising an aldehyde selected from the group consisting of glutaraldehyde and orthophthalaldehyde.

5. The biocidal formulation of claim 4, further comprising water.

6. The biocidal formulation of claim 4, wherein said aldehyde comprises orthophthalaldehyde within a range of 7% to 0.25% and said quaternary phosphonium biocide comprises TTPC within a range of from 50 ppm to 1000 ppm.

7. The biocidal formulation of claim 1, wherein said aldehyde comprises glutaraldehyde within a range of 7% to 0.25% and said quaternary phosphonium biocide comprises TTPC within a range of from 50 ppm to 1000 ppm.

8. The biocidal formulation of claim 1, wherein said isopropyl alcohol is within a range of from 15% to 41%.

9. A biocidal formulation comprising chlorine dioxide (ClO₂) and a quaternary phosphonium biocide, and excipient constituents.

10. The biocidal formulation according to claim 9, wherein said quaternary phosphonium biocide is tetrakis (hydroxymethyl) phosphonium sulfate (THPS).

11. The biocidal formulation according to claim 9, wherein said quaternary phosphonium biocide is tributyl tetradecyl phosphonium chloride (TTPC).

12. The biocidal formulation of claim 9, wherein said ClO₂ is within a range of from 5-500 ppm, and said TTPC is within a range of from 10-500 ppm.

13. The biocidal formulation of claim 9, further comprising an aldehyde selected from the group consisting of glutaraldehyde and orthophthalaldehyde, and water.

14. The biocidal formulation of claim 13, wherein said aldehyde is orthophthalaldehyde within a range of 7% to 0.25% and said quaternary phosphonium biocide is TTPC within a range of from 50 ppm to 1000 ppm.

15. The biocidal formulation of claim 13, wherein said aldehyde is glutaraldehyde within a range of 25% to 0.25% and said quaternary phosphonium biocide is TTPC within a range of from 50 ppm to 1000 ppm.

16. The biocidal formulation of claim 9, further comprising isopropyl alcohol within a range of from 15% to 41%.
